(19) United States
(12) Patent Application Publication
(10) Pub. No.: US 2023/0141493 A1
(43) Pub. Date: May 11, 2023

(54) DEVICE FOR UNMANNED AERIAL VEHICLE TO DEPLOY A RAINFALL CATALYTIC BOMB

(71) Applicant: Autoflight (Kunshan) Co., Ltd., Kunshan City (CN)

(72) Inventor: Yu Tian, Hong Kong SAR (CN)

(21) Appl. No.: 17/983,384

(22) Filed: Nov. 8, 2022

(30) Foreign Application Priority Data
Nov. 8, 2021 (CN) 202122720091.4

(51) Int. Cl. B64C 39/02

(52) U.S. Cl. CPC B64C 39/024; B64C 2201/121; B64C 2201/104

(57) ABSTRACT

A device for unmanned aerial vehicle to deploy a rainfall catalytic bomb deploy which comprises an unmanned aerial vehicle, a cannonball for artificial precipitation and a cylinder, wherein the unmanned aerial vehicle is connected with the cannonball for artificial precipitation through a soft lock, the cannonball for artificial precipitation are multiple and are wrapped in the cylinder, a second sensor is arranged in the cylinder wing surfaces are arranged on the other side of the cylinder, the wing surfaces are multiple and are arranged at one end of the cylinder in the long shaft direction, and one end of the soft lock is connected to the other end of the cylinder in the long shaft direction.

### CROSS-REFERENCES

This application claims priority to China Patent Application No. 202122720091.4, filed on Nov. 8, 2021, now pending, which are hereby incorporated by reference in their entirety.

### FIELD OF THE DISCLOSURE

The application relates to an unmanned aerial vehicle application and artificial rainfall technical field, especially relates to a device for unmanned aerial vehicle to deploy rainfall catalytic bomb.

### BACKGROUND OF THE INVENTION

The existing artificial rainfall modes comprises two modes, one is human-controlled plane and the other one is unmanned aerial vehicle, both loading rainfall catalyst or cannonball for artificial precipitation. For human-controlled plane, it needs a human to sow the rainfall catalyst, the artillery or rocket rains. It needs professional pilots to operate the aircraft, it needs special take-off and landing runway, the operation is complex, it has high requirement on the field, and it can not work in complex weather, the artillery and rocket operation area is small, the efficiency is low and the cost is high.

A common unmanned aerial vehicle carries a rainfall catalyst to fly into an effective cloud layer for rainfall, and due to the fact that the environment in accumulated rain clouds is extremely severe, e.g. strong convection, thunderstorm and lightning stroke, the problems of out-of-control air crash accidents, artificial rainfall failure or low efficiency are prone to occurring.

### SUMMARY OF THE INVENTION

The application aims to provide a device for unmanned aerial vehicle to deploy rainfall catalytic bomb, which solves the problems that an existing common unmanned aerial vehicle carrying a rainfall catalytic bomb is prone to failure and low in efficiency, the unmanned aerial vehicle does not need to enter effective rainfall clouds, the unmanned aerial vehicle can safely operate to reduce the accident rate, and the operation is simple, and the rainfall cost is low. To achieve this purpose, the application uses the following technical solution:

To fulfill the purpose, the application provides a device for unmanned aerial vehicle to deploy rainfall catalytic bomb, comprising an unmanned aerial vehicle, a cannonball for artificial precipitation and a cylinder, the unmanned aerial vehicle connects the cannonball for artificial precipitation through a soft lock, the cannonball for artificial precipitation is multiple, the cannonball for artificial precipitation is provided inside the cylinder, a second sensor is arranged inside the cylinder, the outer side of the cylinder is provided with a wing surface, the wing surface is multiple, the wing surface is arranged on one end of the long shaft direction of the cylinder, the soft lock connects on the other end of the long shaft direction of the cylinder.

Furthermore, the unmanned aerial vehicle provides three wing surfaces, which have the same structure and are respectively arranged on both sides and the top of the cylinder.

Furthermore, the wing surfaces on both sides are horizontal wing and symmetrically disposed on the two sides of the cylinder, the top wing surface is a vertical wing.

Furthermore, the wing surface and the cylinder body are rotatbly connected.

Furthermore, the device for unmanned aerial vehicle to deploy rainfall catalytic bomb further comprises a controller, the controller is configured to control the rotation of the wing surface, the second sensor is set on the middle position of the long shaft direction of the cylinder and is connected with the controller.

Furthermore, the device for unmanned aerial vehicle to deploy rainfall catalytic bomb further includes a first sensor, which is arranged at one end of the soft lock connected with the cannonball for artificial precipitation, and the first sensor is connected with the controller.

Furthermore, the first sensor is a radar sensor, and/or the second sensor is a radar sensor.

Furthermore, the unmanned aerial vehicle is vertical takeoff and landing unmanned aerial vehicle.

Furthermore, the device for unmanned aerial vehicle to deploy rainfall catalytic bomb further comprising an image collector, which is set on the cylinder or on the unmanned aerial vehicle, the image collector is connected with the controller.

Furthermore, the controller is arranged on the ground, on the unmanned aerial vehicle or on the cylinder, and the controller is equipped with a wireless transceiver.

The beneficial effects of the application are as follows:

The application claims a device for unmanned aerial vehicle to deploy rainfall catalytic bomb, using unmanned aerial vehicle carrying rainfall catalytic bomb for rainfall, unmanned aerial vehicle does not need to enter into the cloud layer, rainfall catalytic bomb entering into cloud layer through the soft lock, unmanned machine can reduce accident rate, the operation is simple, and the rainfall cost is low.

In the application, the cylinder of the rainfall catalytic bomb is provided with a second sensor, the position of the rainfall catalytic bomb can be accurately monitored in real time, it is convenient to accurately release the rainfall catalytic bomb and accurately detonate the rainfall catalytic bomb.

The application model is provided with a wing surface on the rainfall catalytic bomb, which is convenient for controlling the stability of the projectile body of the rainfall catalytic bomb itself, especially after the rainfall catalytic bomb enters the cloud layer, because the cloud layer inside is possible to have strong convection phenomenon, the wing surface can control and adjust the posture of the rainfall catalytic bomb, and it is stable, convenient for acquiring the accurate rainfall catalytic bomb for the throwing success rate and throwing efficiency.

### BRIEF DESCRIPTION OF DRAWINGS

FIG. 1 is a schematic diagram of release state of the soft lock on the device for unmanned aerial vehicle to deploy rainfall catalytic bomb in the application.

FIG. 2 is a state schematic diagram before releasing of the soft lock on the device for unmanned aerial vehicle to deploy rainfall catalytic bomb in the application.

FIG. 3 is a structure schematic diagram of the cannonball for artificial precipitation on the device for unmanned aerial vehicle to deploy rainfall catalytic bomb in the application.

In the drawings: 1. unmanned aerial vehicle; 2. cannonball for artificial precipitation; 3. cylinder; 4. soft lock; 5. first sensor; 6. second sensor; 7. wing surface.

### DETAILED DESCRIPTION

The application will be further described in detail with reference to the accompanying drawings and examples. It is to be understood that the specific embodiment described herein only used for the present application, but not the limit of the present application. In addition, it should be noted that, in order to facilitate description, in the accompanying drawings only shows part rather than all of the structure associated with the application.

In the description of the present application, unless otherwise specified and defined, the term “connected”, “fixed” should be generalized understood, for example, can be connected, also can be detachable connected or connected as a whole; it can be mechanical connected, also can be electric connected, can be directly connected, also can be indirectly connected through the intermediate medium. For a person of ordinary skill in the art, it can be specifically understood that the term in the specific meaning of the application.

In the present application, unless otherwise specified and defined, the first feature “above” or “below” the second feature may include the direct contact between the first feature and the second feature, or it may include the contact between the first feature and the second feature not directly but through other features between them. Moreover, the first feature “above”, “above” and “above” the second feature include that the first feature is directly above and obliquely above the second feature, or only indicates that the horizontal height of the first feature is higher than the second feature. The first feature “below”, “beneath and “under” of the second feature include the first feature directly below and obliquely below the second feature, or only indicate that the horizontal height of the first feature is less than the second feature.

In the description of the present embodiment, the term “upper”, “lower”, “right”, the position relation of the orientation or based on the position of the position relation or in the accompanying drawings, only in order to facilitate the description and simplify operation, and not indicating or the device is or component with a specific orientation for indicating the indication, It is constructed and operated in a specific orientation, so it is not to be understood as limiting the present application In addition, the terms “first” and “second” are only used for in the description, and have no special meaning.

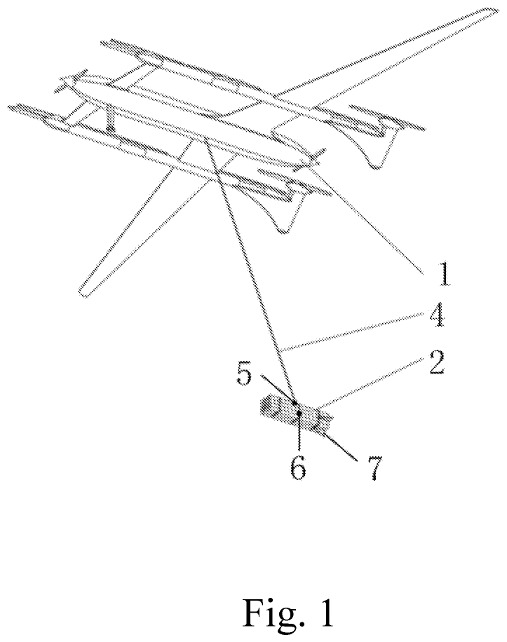

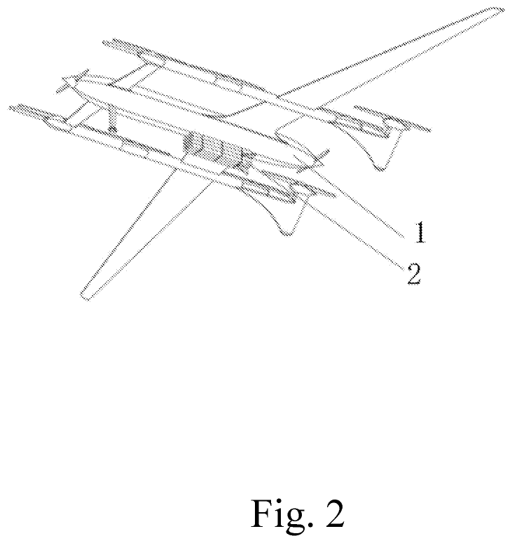

The application provides a device for unmanned aerial vehicle to deploy rainfall catalytic bomb, as shown in FIG. 1 to FIG. 3, comprising an unmanned aerial vehicle 1, a cannonball for artificial precipitation 2 and a cylinder 3, the unmanned aerial vehicle 1 connects the cannonball for artificial precipitation 2 through the soft lock 4. In the initial state, the cannonball for artificial precipitation 2 is detachably connected to the unmanned aerial vehicle 1; in the releasing state, the cannonball for artificial precipitation 2 is suspended below the unmanned aerial vehicle 1 through the soft lock 4. Wherein, the cannonball for artificial precipitation 2 is multiple and arranged in the cylinder 3. The cylinder 3 is further provided with a second sensor 6, and provided with a wing surface 7, which is multiple and is arranged on one end of the long shaft direction of the cylinder 3, the soft lock 4 connects on the other end of the long shaft direction of.

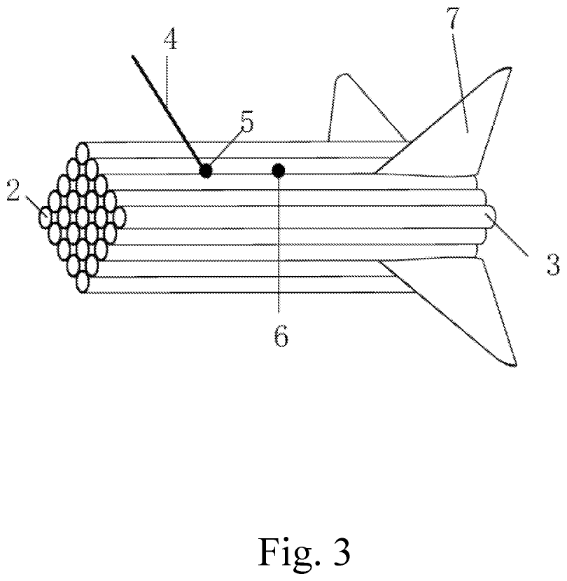

Referring to FIG. 3, the device for unmanned aerial vehicle to deploy rainfall catalytic bomb provided in the application uses an unmanned aerial vehicle 1 to carry the cannonball for artificial precipitation 2 for rainfall, according to the pre-measured position of a cloud system, a flight line of the unmanned aerial vehicle 1 is designed and the unmanned aerial vehicle 1 flies into the upper space of the cloud system, then the cannonball for artificial precipitation 2 is released through a soft lock 4, and the position of the cannonball for artificial precipitation 2 is detected through a second sensor 6, when the detection result shows that the cannonball for artificial precipitation 2 reaches the cloud system or is positioned above the cloud system for a certain distance, then the cannonball for artificial precipitation 2 is released through the soft lock 4 and detonated, and the rainfall is implemented. It can be seen that in the process of implementing rainfall by detonating the cannonball for artificial precipitation 2, the unmanned aerial vehicle 1 does not need to enter the cloud system, the unmanned aerial vehicle 1 can be safely operated to reduce the accident rate, the operation is simple, the rainfall cost is low, and the precise position detonation of the cannonball for artificial precipitation 2 is realized. Therefore, in the application, the position of the cannonball for artificial precipitation 2 can be accurately monitored in real time by arranging the second sensor 6 on the cannonball for artificial precipitation 2, so that the cannonball for artificial precipitation 2 can be conveniently and accurately thrown in and the cannonball for artificial precipitation 2 can be conveniently and accurately detonated. In the application, the wing surfaces 7 are arranged on the cannonball for artificial precipitation 2, and the wing surfaces 7 and the soft lock 4 are respectively arranged at two ends of the long shaft direction of the cylinder 3, so that the stability of the cannonball for artificial precipitation 2 is convenient to control, for example, the posture of the cannonball for artificial precipitation 2 is adjusted by adjusting the length of the soft lock 4, or the posture of the cannonball for artificial precipitation 2 is adjusted by controlling the wing surfaces 7 through the steering engine, especially, after the cannonball for artificial precipitation 2 enters a cloud layer, because strong convection and other phenomena possibly exist in the cloud layer or a cloud system, the posture stability of the cannonball for artificial precipitation 2 can be controlled and adjusted through the wing surfaces 7, the accurate releasing of the cannonball for artificial precipitation 2 is convenient to realize, and the success rate and the efficiency of the release of the cannonball for artificial precipitation 2 are improved.

Furthermore, in this embodiment, the wing surfaces 7 are equipped with three, and three wing surfaces 7 have the same structure and located on both sides and on the top side of the cylinder 3 respectively. The wing surfaces 7 on the two sides are horizontal wings and are symmetrically arranged on the two sides of the cylinder 3, and the top wing surface 7 is a vertical wing.

As shown in FIG. 3, the three wing surfaces 7 have the same structure, the cylinder 3 is a cuboid structure formed by the bonding of several cylinders together, and the plurality of cannonball for artificial precipitation 2 are respectively arranged in the plurality of cylinders 3 so as to space the plurality of rainfall catalytic bomb 2 apart from each other, thereby ensuring that the other rainfall catalytic bomb 2 can be detonated normally under the condition that one cannonball for artificial precipitation 2 fails to be detonated (such as being damaged by moisture). Of course, the cylinder 3 can be set to be a rectangular structure with a rectangular cross section and coated on the outer side of the cannonball for artificial precipitation 2, so as to fix and stabilize the cannonball for artificial precipitation 2 and provide a carrier for connecting and arranging the wing surface 7, the second sensor 6 and the soft lock 4. Three wing surfaces 7 are set on the one end at the cylinder 3, this is convenient for adjusting the gesture and the stability of the cannonball for artificial precipitation 2 and to improve the accurate input, the input efficiency and input success rate.

Moreover, the wing surface 7 and the cylinder body 3 is rotationally connected.

In some embodiment, the wing surface 7 is connected to the cylinder 3 through a rotating shaft, so that the rotation control of the wing surface 7 is realized, and when the wing surface 7 rotates within a certain range, the posture of the cannonball for artificial precipitation 2 can be adjusted, so that accurate throwing is achieved. In a cloud system, the stability of the cannonball for artificial precipitation 2 can be stabilized by adjusting the wing surface 7, and the rainfall catalysis is ensured to be realized.

Further, the unmanned aerial vehicle 1 further comprises a controller, which is not shown in the figure, the controller is configured to control the rotation of the wing surface 7, and the second sensor 6 is arranged in the middle of the long shaft direction of the cylinder 3 and connected with the controller.

It should be noted that, in this embodiment, the controller is provided with the wireless transceiver. Therefore, the controller can be located on ground. Through the wireless communication mode, when the controller is located on the cylinder 3, it is convenient for the unmanned aerial vehicle 1 to implement reliable control through wired mode, and can transmit the releasing gesture of cylinder 3 to unmanned aerial vehicle 1 through wireless mode, and it is convenient to realize the monitoring and the control of the cannonball for artificial precipitation 2. The second sensor 6 is connected to the controller and used for sending the real-time position information of the cannonball for artificial precipitation 2 to the controller, and data interaction is carried out between the controller and the ground monitoring room, so that the position of the cannonball for artificial precipitation 2 and the position of the cloud system can be compared and matched conveniently, and the accurate control on throwing and detonation of the cannonball for artificial precipitation 2 can be achieved.

Furthermore, a first sensor 5 is arranged at one end of the soft lock 4 connected with the cannonball for artificial precipitation 2, and the first sensor 5 is connected with the controller to send the position information of the tail end of the soft lock 4 to the controller. The first sensor 5 is a radar sensor and/or the second sensor 6 is a radar sensor.

The radar sensor has stable detection capability under extreme weather conditions, and it is widely used in aviation field. In this embodiment, the function of first sensor 5 and the second sensor 6 is to locate and feedback the position of the end of the soft lock 4 and the cannonball for artificial precipitation 2 in real time, therefore, other sensors used for positioning and feedback in the prior art can also be selected, such as locator and navigator and so on. The first sensor 5 and the second sensor 6 can be respectively different sensors.

The first sensor 5 and the second sensor 6 can be directly connected with the ground monitoring room by wireless mode. The ground monitoring room can directly receive the position signal of the first sensor 5 and the second sensor 6, it can ensure that the position signal can still be received when the controller on cylinder 3 or unmanned aerial vehicle 1 fails. It still compares the position signal with the cloud system position measured in advance and combines with the release and detonation time of the cannonball for artificial precipitation 2, the timing of the soft lock 4 releasing the cannonball for artificial precipitation 2 can be controlled to achieve precise control and ensure rainfall effect.

Moreover, the first sensor 5 and the second sensor 6 are connected and communicated through a wired cable.

It should be explained that, connecting the first sensor 5 and the second sensor 6 for communication, then sending the signals of the two sensors to the ground monitoring room through the first sensor 5. It can ensure the accuracy and integrity of signals received by the ground monitoring room. It can be understood that there may be lightning above the cloud system at any time, which will affect the normal operation of radar sensors and signal transmission. The positions of the first sensor 5 and the second sensor 6 are the closest, so the signal from the second sensor 6 can be received in time and feedback to the ground monitoring room. It is convenient for the staff in the ground monitoring room to send the detonation control signal to the cannonball for artificial precipitation 2 and achieve precise delivery and detonation

Moreover, the soft lock 4 is provided with multiple. The two ends of multiple soft lock 4 are respectively connected to the interval position on the unmanned aerial vehicle 1 and the interval position on the cannonball for artificial precipitation 2.

In this embodiment, when multiple cannon ball for artificial precipitation 2 are carried on the unmanned aerial vehicle 1 at the same time, each cannonball for artificial precipitation 2 is connected through soft lock 4 to control each cannonball for artificial precipitation 2 separately. For one cannonball for artificial precipitation 2, more than two soft locks 4 can also be used to connect it, so as to ensure the release attitude of the cannonball for artificial precipitation 2 and ensure the detonating effect. In some embodiment, the attitude and stability of the cannonball for artificial precipitation 2 can be adjusted to improve the delivery accuracy by adjusting the length of multiple soft locks 4 and cooperating with the wing surface 7 on the cylinder 3,

Moreover, the second sensor 6 is provided with multiple. Multiple second sensors 6 are spaced on the cannonball for artificial precipitation 2.

In this embodiment, considering the release attitude of the cannonball for artificial precipitation 2, it can be positioned by multiple second sensors 6 for attitude adjustment. More than two second sensors 6 can be used as a backup. If one of the second sensors 6 fails, it can ensure that there are other second sensors 6 to send position signals to the ground monitoring room or controller.

Furthermore, the unmanned aerial vehicle 1 is vertical takeoff and landing unmanned aerial vehicle.

Furthermore, the fixed wing vertical takeoff and landing unmanned aerial vehicle is selected as the large load capacity and long endurance time, less energy consumption. In combination with the positioning detection of the first sensor 5 and the second sensor 6 in the application, rapid and accurate release of the cannonball for artificial precipitation 2 can be achieved.

Moreover, the device for unmanned aerial vehicle to deploy cannonball for artificial precipitation further comprises an image collector (not shown in the figure), the image collector is set on the unmanned aerial vehicle 1 or the cylinder 3, and is connected with the controller.

The device for unmanned aerial vehicle to deploy cannonball for artificial precipitation in the application is used to detect the cloud system position by radar in advance, and the unmanned aerial vehicle 1 is designed to attach cannonball for artificial precipitation 2 to release cannonball for artificial precipitation 2 when flying to the sky above the cloud system. It can be understood that the cloud system is dynamically changing. It is necessary to monitor the distribution of cloud system in real time to control the flight path of unmanned aerial vehicle 1, so as to achieve the purpose of effective rainfall. An image collector is set on the unmanned aerial vehicle 1, which can take pictures of the cloud system below the unmanned aerial vehicle 1 and transmit them to the controller or ground monitoring room (the controller is set on the ground) to judge whether the cloud system needs to release the cannonball for artificial precipitation 2, It can be understood that the image collector can monitor the position and status of the cloud system in real time, so as to apply a flexible delivery solution in real time.

It can be understood that it has better maneuverability and flexibility when the image collector is set on the unmanned aerial vehicle 1 the controller is set on the ground. Wireless connection is used for signal transmission and the signal is stable. It is not affected by the change of unmanned aerial vehicle 1 flight route.

Moreover, the image collector can be a camera.

As a solution, the unmanned aerial vehicle 1 is provided with a camera as an image collector, the camera shot image is transmitted to the ground controller in real time. It is convenient for the ground to analyze and judge the real-time state of the cloud system, to determine whether the cannonball for artificial precipitation 2 is put in. delivery position and so on. Specifically, the camera can be directly communicated with the ground controller, also can be transmitted together with other sensor signal on the unmanned aerial vehicle 1.

Obviously, the above embodiments of the present application are only for the sake of clarity of illustration, and not the limitation of the embodiment of the present application. For those of ordinary skill in the art, various obvious changes can be made, and readjustment and replacement will not be separated from the protection scope of the present application. There is no need for the exhaustive of all the embodiment. Any modification made within the spirit and principle of the present application, equivalent replacement and improvement and so on, should be included in the protection application of the Claims.

1. A device for an unmanned aerial vehicle to deploy a rainfall catalytic bomb, comprising an unmanned aerial vehicle (1), a cannonball for artificial precipitation (2) and a cylinder (3), the unmanned aerial vehicle (1) connects the cannonball for artificial precipitation (2) through a soft lock (4), which is characterized in that the cannonball for artificial precipitation (2) is multiple, the cannonball for artificial precipitation (2) is provided inside the cylinder (3), a second sensor (6) is arranged inside the cylinder (3), the outer side of the cylinder (3) is provided with a wing surface (7), the wing surface (7) is multiple, wherein the wing surface (7) is arranged on one end of the long shaft direction of the cylinder (3), the soft lock (4) connects on the other end of the long shaft direction of the cylinder (3).

2. The device for unmanned aerial vehicle to deploy rainfall catalytic bomb, according to claim 1, which is characterized in that the unmanned aerial vehicle provides three wing surfaces (7), which have the same structure and are respectively arranged on both sides and the top of the cylinder (3).

3. The device for unmanned aerial vehicle to deploy rainfall catalytic bomb according to claim 2, which is characterized in that the wing surfaces on both sides (7) are horizontal wing and symmetrically disposed on the two sides of the cylinder (3), the top wing surface (7) is a vertical wing.

4. The device for unmanned aerial vehicle to deploy rainfall catalytic bomb according to claim 1, the wing surface (7) and the cylinder body (3) are rotatably connected.

5. The device for unmanned aerial vehicle to deploy rainfall catalytic bomb according to claim 1, further comprises a controller, the controller is configured to control the rotation of the wing surface (7), the second sensor (6) is set on the middle position of the long shaft direction of the cylinder (3) and is connected with the controller.

6. The device for unmanned aerial vehicle to deploy rainfall catalytic bomb according to claim 5, further includes a first sensor (5), which is arranged at one end of the soft lock (4) connected with the cannonball for artificial precipitation (2), and the first sensor (5) is connected to the controller.

7. The device for unmanned aerial vehicle to deploy rainfall catalytic bomb according to claim 6, the first sensor (5) is a radar sensor, and/or the second sensor (6) is a radar sensor.

8. The device for unmanned aerial vehicle to deploy rainfall catalytic bomb according to claim 1, wherein the unmanned aerial vehicle (1) is vertical takeoff and landing unmanned aerial vehicle.

9. The device for unmanned aerial vehicle to deploy rainfall catalytic bomb according to claim 5, further comprising an image collector, which is set on the cylinder or on the unmanned aerial vehicle (1), the image collector is connected to the controller.

10. The device for unmanned aerial vehicle to deploy rainfall catalytic bomb according to claim 5, the controller is arranged on the ground, on the unmanned aerial vehicle (1) or on the cylinder (3), and the controller is equipped with a wireless transceiver.
